(19) United States
(12) Patent Application Publication
(10) Pub. No.: US 2004/0121812 A1
(43) Pub. Date: Jun. 24, 2004

(54) Method of performing speech recognition in a mobile title line communication device

(76) Inventors: Patrick J. Doran, Plantation, FL (US); Sheetal R. Shah, Cupertino, CA (US)

Correspondence Address: Scott M. Garrett, Motorola, Inc., Law Department, 8000 West Sunrise Boulevard, Fort Lauderdale, FL, 33322, US

(21) Appl. No.: 10/324,435

(22) Filed: Dec. 20, 2002

(51) Int. Cl. H04M 1/64; H04M 1/00; H04B 1/38

(52) U.S. Cl. 455/563; 379/88.01

(57) ABSTRACT

In performing speech or voice recognition, a start point (306) is identified (214). The mobile communication device is provided with an automatic voice recognition algorithm. In noisy environments, however, excess noise may cause the automatic voice recognition algorithm to falsely determine that the noise is speech. Including the noise that occurs before the user actually begins speaking substantially reduces the ability of the voice recognition algorithm to correlate the audio signal with a voice template. To eliminate the effect the noise preamble would have if included by the automatic speech algorithm, the mobile communication device is provided with a user interface (210) that allows the user to assert a speech interrupt (220), causing the start point to be reset (222) at the time the speech interrupt becomes active (306), thereby disposing of the noise preamble.

### TECHNICAL FIELD

This invention relates in general to voice recognition in mobile communication devices, and more particularly to identifying the beginning and end of a speech segment for use in voice recognition.

### BACKGROUND

Mobile communication devices are in widespread use throughout the world, and are used by substantial portions of the populations of metropolitan regions. In recent years the cost of these devices has dropped considerably, and manufacturers no longer compete on simply making the least expensive mobile communication device, but now compete by adding features and functionality to mobile communication devices. One such feature is voice recognition.

Voice recognition has been employed in mobile communication devices as an extension of the user interface. It allows a user to speak a command and have the mobile communication device automatically take a desired action. For example, most mobile communication devices now allow a user to store phone numbers and names of other parties the user may wish to call. With voice recognition, the user may, for example, speak “call” followed by the name of party to be called. The voice recognition algorithm compares a speech signal sample to template or so called voice tags to determine what the user has said.

One of the critical operations of speech recognition is to determine when the user begins and stops speaking. Simple automatic voice recognition algorithms start capturing the audio signal when the level of the audio signal exceeds a preselected threshold magnitude on the assumption that the increased signal level is due to the user speaking into a microphone of the device. An alternative means of capturing the speech is for the user of the device to, for example, press a button on the device. When the button is first pressed, the device begins sampling the audio signal, and stops sampling when the button is released. In this manner no automatic start and end point determination is needed. However, there are problems associated with each of these methods.

The automatic start and end point determination method works well in quiet environments. However, when the device is in a noisy environment, the automatic start and end point determination algorithm falsely detects speech because of the high magnitude of ambient noise. False speech detection substantially decreases the ability of the voice recognition algorithm to match the speech with a voice template or tag. The response to this problem has been to refine the automatic start and end point detection criteria so as to make the process more effective. The push button method is sought to be avoided whenever possible, but particularly in mobile devices. The goal of voice recognition is to avoid requiring the user to operate a keypad or buttons. Regardless of the method implemented, the other method is excluded. The presence of one means of detecting speech start and end points disposes of the need for any other means.

### BRIEF DESCRIPTION OF THE DRAWINGS

FIG. 1 shows a block schematic diagram of a mobile communication device in accordance with the invention;

FIG. 2 shows a flow chart diagram of a method of performing speech recognition in a mobile communication device, in accordance with the invention; and

FIG. 3 shows a graph chart diagram of an audio signal for illustrating operation of a method of performing speech recognition in a mobile communication device, in accordance with the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

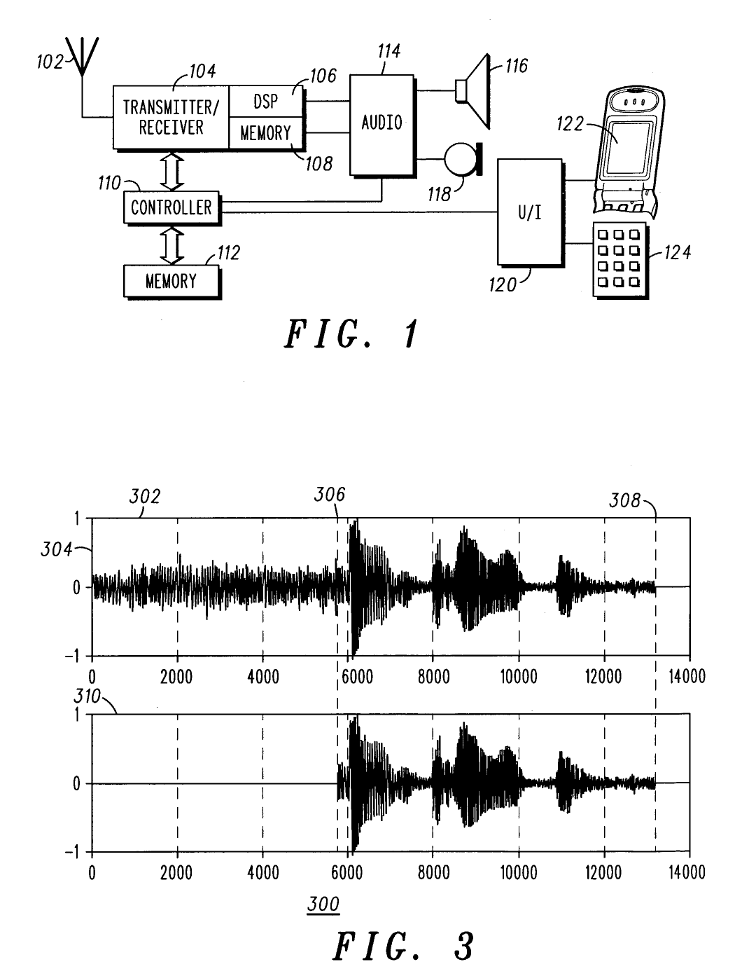

Referring now to FIG. 1, there is shown a block schematic diagram of a mobile communication device 100 for performing voice recognition in accordance with the invention. It will be appreciated by those skilled in the art that there are numerous variations in which a mobile communication device may be configured. The particular configuration shown here is not meant to limit the configuration to which the invention applies. The mobile communication device comprises an antenna 102 for transmitting and receiving radio frequency signals. The antenna is coupled to a transceiver 104 which up mixes signals to be transmitted and downmixes signals that are received, as is well practiced in the art. Integrated into the transceiver is a digital signal processor (DSP) 106 which performs a variety of functions, including encoding and decoding signals, filtering, and so on. The DSP may have a local memory 108 for storing operating code and scratchpad variables as needed. The transceiver is operably coupled to a controller 110 which controls and coordinates operation of the various components of the mobile communication device, according to instruction code stored in a main memory 112, which typically includes both read only memory and random access memory. Read only memory may be permanent, or reprogrammable memory, such as so called flash memory. Coupled to the transceiver is an audio processor 114, which converts digital signals received from the transceiver to analog signals to be amplified and played over a speaker 116, and converts analog signals received from a microphone 118 into digital signals which are passed to the transceiver. The audio processor is controlled by the controller. The mobile communication device also comprises a user interface processor 120 which, among other components, operates a display 122 and a keypad and other buttons 124. The user interface may also drive the audio processor 114 through the controller to cause audio signals to be emitted at certain times. Typically most of the buttons have prescribed functions, and a few are used as soft keys. Soft keys work in conjunction with the display so that their function changes in context with a present operating mode of the mobile communication device. The display shows indicia corresponding to the present function of the button if pressed or actuated by the user, and the button is located in close proximity to the display where the indicia is displayed. According to the invention, the user interface provides a way for a user of the device to interrupt an automatic speech recognition algorithm. The interruption is preferable performed upon the user pushing a button, but it is contemplated that other means may be provided so that the user may indicate a desired to interrupt the automatic speech recognition algorithm, such as, for example, a touch screen display.

Thus the invention provides 7. A mobile communication device having an automatic voice recognition mode and a manual voice recognition mode for overriding the automatic voice recognition mode. The manual voice recognition mode is engaged when a user of the mobile communication device actuates a button of the mobile communication device. The manual voice recognition mode overrides the automatic voice recognition mode by setting a start point in an audio signal received at the mobile communication device for performing voice recognition. The manual voice recognition mode sets an endpoint of an audio signal received at the mobile communication device for performing voice recognition upon disengagement of the manual voice recognition mode.

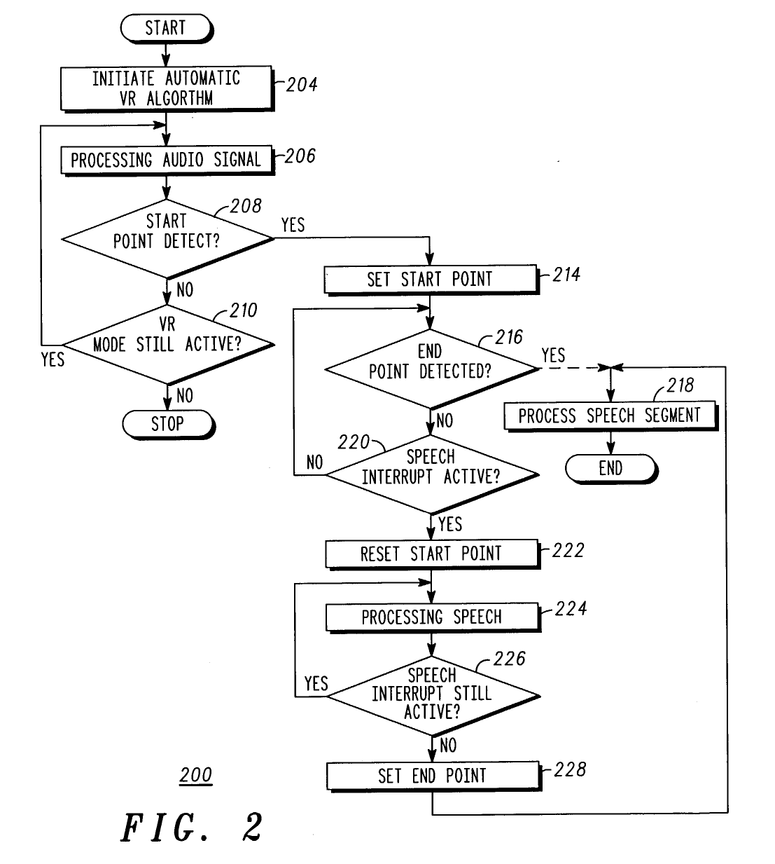

Referring now to FIG. 2, there is shown a flow chart diagram 200 of a method for performing speech recognition in a mobile communication device, in accordance with the invention. The flow chart 200 illustrates one embodiment of the invention, but it should be kept in mind that the invention provides both an automatic voice recognition mode and a manual voice recognition mode for overriding the automatic voice recognition mode at any time while the automatic voice recognition mode is engaged.

At the start 202 the mobile communication device is operating and powered on. The user operates the user interface to cause an automatic speech recognition algorithm or process to commence 204. Typically this means the mobile communication device enters a mode where it “listens” to the user for voice commands. Upon the automatic speech recognition algorithm commencing, the mobile communication device begins receiving an audio signal from the microphone. However, for the sake of simplicity, some assumptions are typically made as to when the user is actually speaking. In order to execute a desired command, the mobile communication device must be able to recognize the command. Recognizing the command comprises comparing the received speech with voice templates or tags to find a probable match corresponding to a desired action or data object. For example, a user may speak “call Patrick” and the automatic speech recognition would, under appropriate conditions, first recognize “call” and determine that the user desires to initiate a call. Second, the automatic speech recognition process would recognize “Patrick” as the target, and locate a record in the memory of the mobile communication device corresponding to the matching template, and obtain the associated phone or calling number and initiate a call with the number.

In order to match the spoken words with voice templates, the automatic speech recognition algorithm must determine when the user begins and ends speaking so as to achieve a high probability of a match, and also to differentiate spoken words. The process of identifying the start and end points of speech is known as endpoint detection. There are a variety of ways of automatically identifying endpoints. As used here, the term “automatic” refers to a process where the machine performs the task without input from the user to facilitate decision making with regard to the task. Perhaps the simplest method of identifying start and end points is to select a threshold with which to compare the audio signal produced by the microphone. When the audio signal exceeds the threshold, or when the average level of the audio signal over a short period of time exceeds the threshold, it is assumed that the user is speaking, and the mobile communication device begins recording the speech until the audio signal level recedes below the threshold, indicating a cessation of speech. The stored information is then compared to pre-stored voice templates using various correlation methods to identify a match, if any can be found.

Therefore, according to the invention, the mobile communication device, after the automatic voice recognition algorithm begins, receiving and processing audio signals (206) from the microphone. Referring briefly to FIG. 1, the microphone 118 converts acoustic waves to electrical signals. The audio processor 114 amplifies these signals and digitizes them by sampling the magnitude periodically, typically at a rate of 8 KHz in telephony applications. The digitized sample stream is passed to the DSP 106, which, in the present example, is responsible for executing voice recognition.

While the samples are streaming in from the audio processor, the DSP, upon executing the automatic speech recognition functions, evaluates the audio signal to detect a start point of a speech signal (208). If the predefined criteria indicating a speech start point is not found, the mobile communication device may check to see if voice recognition mode is still active (210), or if the user has selected some other function. If the predefined criteria are met while searching for a speech start point, the start point is set (214) and the audio signal is buffered, beginning at the start point.

Once the start point is detected and set, the device begins to search for an end point (216). At the same time, the device may begin comparing the buffered audio signal to voice templates as it is accumulated. If an endpoint is detected, the device will also process the speech segment to try and correlate the buffered audio signal with a voice template (218). If the endpoint is detected, the speech segment is processed normally (218). However, it is contemplated that the start point may have been falsely detected due to the presence of excessive noise in the audio signal.

If the start point was erroneously set due to excessive noise, then what is recorded is noise, at least up until the user begins speaking. This noise preamble degrades the ability of the speech recognition algorithm to match what was spoken with stored voice templates. Furthermore, the continued presence of noise may mean that an end point is not detected according to the predefined end point criteria. In such an instance, the user may speak the desired action or command, but the mobile communication device is unable to recognize the speech and fails to perform the desired action. In response, in accordance with the invention, the user recognizes the failure of the voice recognition process. However, rather than undertake a multi-action manual sequence to perform the desired task manually, the user, for example, presses a button, causing an speech interrupt to become active. The mobile communication device, while attempting to detect an end point checks to see if the speech interrupt is active (220). If the speech interrupt is not active, the mobile communication device continues to alternatively check for an end point and checking for the speech interrupt. If the speech interrupt has become active the start point is reset (222) to the time when the speech interrupt was detected in anticipation of the user speaking. The speech interrupt may be set to active by pressing and holding the button, or pressing and releasing the button once to toggle the speech interrupt on, and subsequently pressing and releasing it again when the user is finished speaking to toggle the speech interrupt back to inactive. Once the start point has been reset, the automatic voice recognition algorithm proceeds normally, buffering speech, and possibly making interim comparisons with voice templates while the speech interrupt is active (226). Once the speech interrupt is no longer active, the end point is set at the time when it is discovered that the speech interrupt is no longer active (228). The buffered speech segment is them processed normally (218) to obtain a match with a voice template, and the mobile communication device undertakes the corresponding action.

FIG. 3 shows a graph chart diagram 300 illustrating operation of the invention. There are show two similar graphs 302 and 310, respectively. Both graphs show the occurrence of a speech segment beginning slightly after 6000 samples have occurred. Prior to that time however, in the first graph, there can be seen a high amount of noise. In the present example, the automatic voice recognition algorithm begins evaluating the received audio at the beginning 304 of the first graph 302. In the present example, the noise present at 304 is sufficiently energetic to satisfy the predefined criteria for declaring speech present by the automatic voice recognition algorithm. However, the user doesn't actually begin speaking until 306. The second graph 310 shows how the same signal appears without the excessive background noise. The buffered audio signal in between 304 and 306 in the first graph substantially degrades the ability of voice recognition algorithm to find a matching voice template, even if the noise ceases once the user begins speaking, because the voice recognition system is attempting to match the noise and the speech to a voice template.

However, according to the invention, at time 306, the user of the mobile communication device causes the speech interrupt to become active. In response, the mobile communication device resets the start point from the beginning 304 to the time the speech interrupt became active 306. According to the present example, the speech interrupt is no longer active at time 308. Thus the audio signal buffered between times 306 and 308 is used to find a matching voice template. Even if noise continues to be present during that time, the shortened segment allows for better correlation than if the preceding noise is included.

Therefore the invention provides a method of performing speech recognition in a mobile communication device, in the presence of noise. The method includes commencing an automatic voice recognition algorithm for recognizing speech commands spoken by a user of the mobile communication device when the user so desires to have voice recognition mode enabled. Once the voice recognition mode is enabled the mobile communication device begins receiving an audio signal from a microphone of the mobile communication device. However, when the user is operating the mobile communication device in a noisy environment, setting a speech start point in the audio signal by the automatic speech recognition algorithm can occur in response to the noise, instead of actual speech. Once the start point is set the mobile communication device commences searching for a speech endpoint in the audio signal. At the same time, the mobile communication device checks to see if the speech interrupt has become active. The speech interrupt is generated in response to the user of the mobile communication device operating the user interface, such as, for example, by pressing a speech interrupt button. Thus, while searching for the speech endpoint, the method involves resetting the speech start point upon the speech interrupt becoming active. The method then calls for setting the speech endpoint when the speech interrupt ceases to be active. Once the speech end point the set, the audio signal between the reset start point and end point are used in matching the speech a voice template. While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method of performing speech recognition in a mobile communication device, comprising:
commencing an automatic voice recognition algorithm for recognizing speech commands spoken by a user of the mobile communication device;
receiving an audio signal from a microphone of the mobile communication device;
setting a speech start point in the audio signal by the automatic speech recognition algorithm;
searching for a speech endpoint in the audio signal by the automatic speech algorithm after setting the speech start point;
while searching for the speech endpoint, resetting the speech start point upon a speech interrupt from a user interface of the mobile communication device becoming active; and
setting the speech endpoint when the speech interrupt ceases to be active.

2. A method of performing speech recognition in a mobile communication device as defined in claim 1, further comprising, after setting the speech endpoint when the speech interrupt ceases to be active, matching the portion of the audio signal between the speech start point and speech endpoint with a voice template.

3. A method of performing speech recognition in a mobile communication device as defined in claim 1, wherein setting the speech start point in the audio signal by the automatic speech recognition algorithm is performed in response to noise, and wherein the signal level of the noise exceeds a voice energy threshold.

4. A method of performing speech recognition in a mobile communication device as defined in claim 1, wherein resetting the speech start point upon a speech interrupt from a user interface of the mobile communication device becoming active comprises the user of the mobile communication device pressing a designated button and releasing the designated button.

5. A method of performing speech recognition in a mobile communication device as defined in claim 1, wherein setting the speech endpoint when the speech interrupt ceases to be active comprises the user of the mobile communication device pressing a designated button and releasing the designated button.

6. A method of performing speech recognition in a mobile communication device as defined in claim 1, wherein resetting the speech start point upon a speech interrupt from a user interface of the mobile communication device becoming active comprises the user of the mobile communication device pressing and holding a designated button, and setting the speech endpoint when the speech interrupt ceases to be active comprises the user of the mobile communication device releasing the designated button.

7. A mobile communication device, comprising
an automatic voice recognition mode; and
a manual voice recognition mode for overriding the automatic voice recognition mode.

8. A mobile communication device as define in claim 7, wherein the manual voice recognition mode is engages while a user of the mobile communication device actuates a button of the mobile communication device.

9. A mobile communication device as define in claim 7, wherein the manual voice recognition mode overrides the automatic voice recognition mode by setting a start point in an audio signal received at the mobile communication device for performing voice recognition.

10. A mobile communication device as define in claim 7, wherein the manual voice recognition mode sets an endpoint of an audio signal received at the mobile communication device for performing voice recognition upon disengagement of the manual voice recognition mode.
